(19) United States
(12) Patent Application Publication
(10) Pub. No.: US 2025/0176021 A1
(43) Pub. Date: May 29, 2025

(54) MULTIPLE USER SUBSCRIBER IDENTITY MODULE GAP SIGNALING

(71) Applicant: QUALCOMM Incorporated, San Diego, CA (US)

(72) Inventors: Mickael MONDET, Louannec (FR); Yih-Hao LIN, San Diego, CA (US); Peerapol TINNAKORNSRISUPHAP, San Diego, CA (US)

(21) Appl. No.: 18/521,802

(22) Filed: Nov. 28, 2023

(51) Int. Cl. H04W 74/08; H04W 88/04

(52) U.S. Cl. CPC H04W 74/0816; H04W 88/04

(57) ABSTRACT

Various aspects of the present disclosure generally relate to wireless communication. In some aspects, a user equipment (UE) may signal an indication of a start of a multiple user subscriber identity module (MUSIM) gap and an indication of an end of the MUSIM gap. The UE may transmit information associated with the MUSIM gap. Numerous other aspects are described.

### FIELD OF THE DISCLOSURE

Aspects of the present disclosure generally relate to wireless communication and specifically relate to techniques, apparatuses, and methods for multiple user subscriber identity module gap signaling.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes signaling, by a modem of the UE to an application component of the UE via a cross-layer application programming interface (API), an indication of a start of a multiple user subscriber identity module (MUSIM) gap and an indication of an end of the MUSIM gap; and transmitting, by the application component of the UE to an edge device via in-band signaling, information associated with the MUSIM gap.

In some aspects, a method of wireless communication performed by an edge device includes receiving, from an application component of a UE via in-band signaling, information associated with a MUSIM gap; and transmitting, to the UE, one or more frames based at least in part on the information associated with the MUSIM gap.

In some aspects, an apparatus for wireless communication at a UE includes one or more memories; and one or more processors, coupled to the one or more memories, configured to cause the UE to: signal, by a modem of the UE to an application component of the UE via a cross-layer API, an indication of a start of a MUSIM gap and an indication of an end of the MUSIM gap; and transmit, by the application component of the UE to an edge device via in-band signaling, information associated with the MUSIM gap.

In some aspects, an apparatus for wireless communication at an edge device includes one or more memories; and one or more processors, coupled to the one or more memories, configured to cause the edge device to: receive, from an application component of a UE via in-band signaling, information associated with a MUSIM gap; and transmit, to the UE, one or more frames based at least in part on the information associated with the MUSIM gap.

In some aspects, a non-transitory computer-readable medium storing a set of instructions for wireless communication includes one or more instructions that, when executed by one or more processors of a UE, cause the UE to: signal, by a modem of the UE to an application component of the UE via a cross-layer API, an indication of a start of a MUSIM gap and an indication of an end of the MUSIM gap; and transmit, by the application component of the UE to an edge device via in-band signaling, information associated with the MUSIM gap.

In some aspects, a non-transitory computer-readable medium storing a set of instructions for wireless communication includes one or more instructions that, when executed by one or more processors of an edge device, cause the edge device to: receive, from an application component of a UE via in-band signaling, information associated with a MUSIM gap; and transmit, to the UE, one or more frames based at least in part on the information associated with the MUSIM gap.

In some aspects, an apparatus for wireless communication includes means for signaling, by a modem of the apparatus to an application component of the apparatus via a cross-layer API, an indication of a start of a MUSIM gap and an indication of an end of the MUSIM gap; and means for transmitting, by the application component of the apparatus to an edge device via in-band signaling, information associated with the MUSIM gap.

In some aspects, an apparatus for wireless communication includes means for receiving, from an application component of a UE via in-band signaling, information associated with a MUSIM gap; and means for transmitting, to the UE, one or more frames based at least in part on the information associated with the MUSIM gap.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture in accordance with the present disclosure.

FIG. 4 is a diagram illustrating an example of multiple user subscriber identity module (MUSIM) enabled communications, in accordance with the present disclosure.

FIG. 5 is a diagram illustrating an example of MUSIM gap signaling, in accordance with the present disclosure.

FIGS. 6A-6E are diagrams illustrating examples of MUSIM gap signaling, in accordance with the present disclosure.

FIGS. 7A-7C are diagrams illustrating examples of service adaptation from MUSIM gap signaling, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at an edge device or an apparatus of an edge device, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may communicate with a network node. The UE may be an extended reality (XR) device, such as a virtual reality (VR) headset with on-device processing. The network node may communicate with an edge device. The edge device may be (or may include) an application server associated with an application operating on the UE. The UE may communicate with the network node (and/or the application server) using multiple user subscriber identity module (MUSIM) communications. For example, the UE may communicate with a first network (and/or first mobile network operator (MNO)) using a first subscriber identity module (SIM) (for example, SIM A) and may communicate with a second network (and/or second MNO) using a second SIM (for example, SIM B). However, the UE may only communicate on a single network at a given time. For example, a UE that is connected to the first network using SIM A may need to switch to the second network prior to communicating on the second network using SIM B. Additionally, there may not be any coordination between the networks and mobile network operators. For example, the first network and the second network may not be able to coordinate handovers associated with the UE. In some examples, the UE may need to be able to receive a mobile-terminated (MT) call in one network (for example, the second network) while being in a radio resource control (RRC) connected state in another network (for example, the first network). Additionally, the UE may need to be able to receive paging in both networks while the UE is in an RRC idle state (for example, with respect to both networks). Further, when receiving a paging message in the second network while being RRC connected to the first network, the UE may need to be able to notify the first network that the UE is to leave the first network (for example, to answer the paging in the second network).

The UE may be configured with one or more MUSIM gaps. A MUSIM gap may be a period of time during which the UE suspends operations in a network. For example, a UE that is RRC connected to the first network may not perform any communications in the first network during a MUSIM gap that occurs in the first network. In some cases, the UE may be RRC configured with up to three periodic MUSIM gaps and a single aperiodic (for example, one-shot) MUSIM gap. The periodic MUSIM gaps may be for cell measurements, system information (SI) reception, and paging monitoring, and the aperiodic MUSIM gaps may be for on-demand SI requests (for example, associated with a random access channel (RACH) procedure). In some cases, the UE may report one or more preferences regarding the quantity of MUSIM gaps and associated MUSIM gap configurations via a UE assistance information message. In some examples, to be able to receive paging in the second network while being RRC connected to the first network, the UE may need to perform cell identification, selection, and reselection, system information block (SIB) acquisition, on-demand SIB request(s), and paging monitoring in the second network. In some cases, a MUSIM gap in a network may interrupt services that are ongoing in the network. For example, a MUSIM gap in the first network may result in the UE failing to receive uplink data (and/or failing to transmit downlink data) using the first network, which may increase latency and/or otherwise disrupt a user experience.

Various aspects relate generally to wireless communications. Some aspects more specifically relate to MUSIM gap signaling. In some aspects, a modem of a UE may signal, to an application component of the UE via a cross-layer application programming interface (API), an indication of a start of a MUSIM gap and an indication of an end of the MUSIM gap. In some aspects, the indication of the end of the MUSIM gap may be an indication of a duration of the MUSIM gap. In some aspects, the application component of the UE may signal, to the modem of the UE, an indication of a minimum duration of the MUSIM gap. The modem of the UE may refrain from signaling information associated with a MUSIM gap having a duration that is less than the minimum duration. In some aspects, the application component of the UE may signal, to the modem of the UE, an indication of a minimum distance between the MUSIM gap and a subsequent MUSIM gap. The modem of the UE may process the MUSIM gap and the subsequent MUSIM gap as a single (combined) MUSIM gap based at least in part on a distance between the MUSIM gap and the subsequent MUSIM gap being less than the minimum distance. In this example, a duration of the single MUSIM gap may be equal to a sum of a duration of the MUSIM gap, a duration of the subsequent MUSIM gap, and a duration between the MUSIM gap and the subsequent MUSIM gap. The application component of the UE may transmit, to an edge device via in-band signaling, information associated with the MUSIM gap. The information associated with the MUSIM gap may include the indication of the start of the MUSIM gap and the indication of the end of the MUSIM gap (and/or the indication of the duration of the MUSIM gap). Additionally, or alternatively, the information associated with the MUSIM gap may include an indication of an availability of a radio link for communications that include the MUSIM gap. In some aspects, transmitting the information associated with the MUSIM gap may include transmitting, by the application component of the UE to the edge device via in-band signaling, an indication that one or more downlink frames are to collide with the MUSIM gap. The application component of the UE may adapt an uplink service flow that is based at least in part on the information associated with the MUSIM gap. Additionally, or alternatively, the edge device may adapt a downlink service flow that is based at least in part on the information associated with the MUSIM gap.

Particular aspects of the subject matter described in this disclosure can be implemented to realize one or more of the following potential advantages. In some examples, by signaling the information associated with the MUSIM gap, the described techniques can be used to improve a reliability of communications between the application component of the UE and the edge device. For example, by signaling the indication of the start of the MUSIM gap and the indication of the end of the MUSIM gap, the described techniques can be used to enable the application component of the UE to adapt an uplink service flow that is based at least in part on the information associated with the MUSIM gap. Additionally, or alternatively, by signaling the indication of the start of the MUSIM gap and the indication of the end of the MUSIM gap, the described techniques can be used to enable the edge device to adapt a downlink service flow that is based at least in part on the information associated with the MUSIM gap. This may reduce a latency of communications between the application component and the edge device, and may reduce a likelihood of content playback interruption at the UE. In some examples, by signaling the minimum duration of the MUSIM gap, the described techniques can be used to enable the application component of the UE to ignore MUSIM gaps having durations that are less than the minimum duration (for example, MUSIM gaps that are too short to be used by the application component). In some examples, by signaling the minimum distance between the MUSIM gap and a subsequent MUSIM gap, the described techniques can be used to enable the application component to combine MUSIM gaps when a duration between the MUSIM gaps does not satisfy the minimum distance. In some examples, by transmitting the indication that one or more downlink frames are to collide with the MUSIM gap, the described techniques can be used to enable the application component of the UE to adapt an uplink service flow that is based at least in part on an arrival pattern of one or more previous frames and/or to enable the edge device to adapt a downlink service flow that is based at least in part on the arrival pattern of the one or more previous frames. These example advantages, among others, are described in more detail below.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

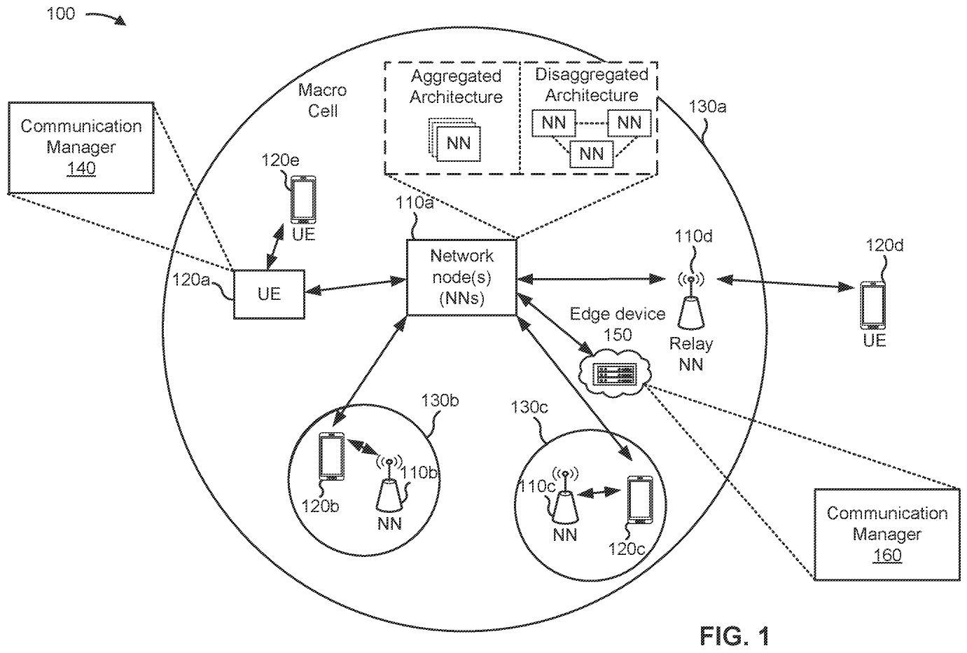

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e. In some examples, the wireless communication network 100 may include one or more edge devices 150. The edge device 150 may include an application server and/or may be configured to provide the UE 120 (for example, via the network node 110) with application data to be displayed via a display of the UE 120.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may signal, via a cross-layer API, an indication of a start of a MUSIM gap and an indication of an end of the MUSIM gap; and transmit, via in-band signaling, information associated with the MUSIM gap. Additionally, or alternatively, the communication manager 140 may perform one or more other operations described herein.

In some aspects, the edge device 150 may include a communication manager 160. As described in more detail elsewhere herein, the communication manager 160 may receive, from a UE via in-band signaling, information associated with a MUSIM gap; and transmit, to the UE, one or more frames based at least in part on the information associated with the MUSIM gap. Additionally, or alternatively, the communication manager 160 may perform one or more other operations described herein.

As indicated above, FIG. 1 is provided as an example. Other examples may differ from what is described with regard to FIG. 1.

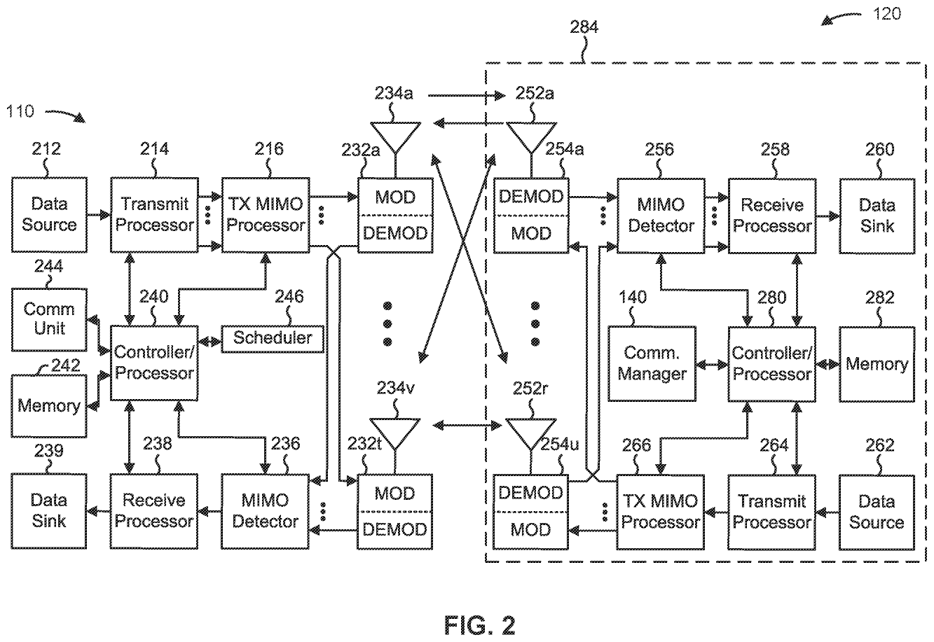

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

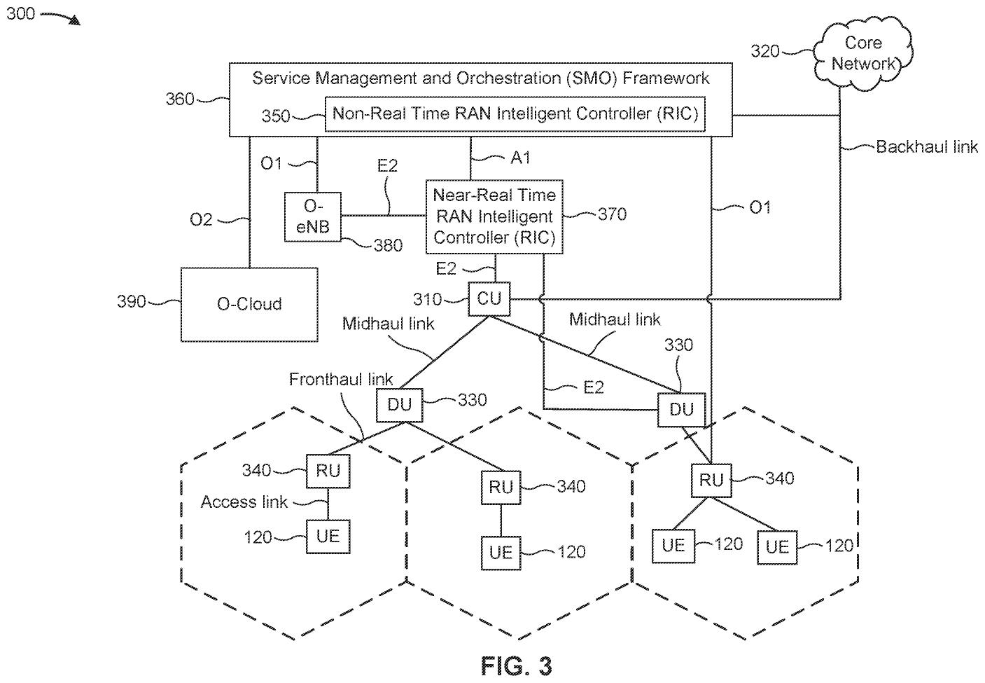

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

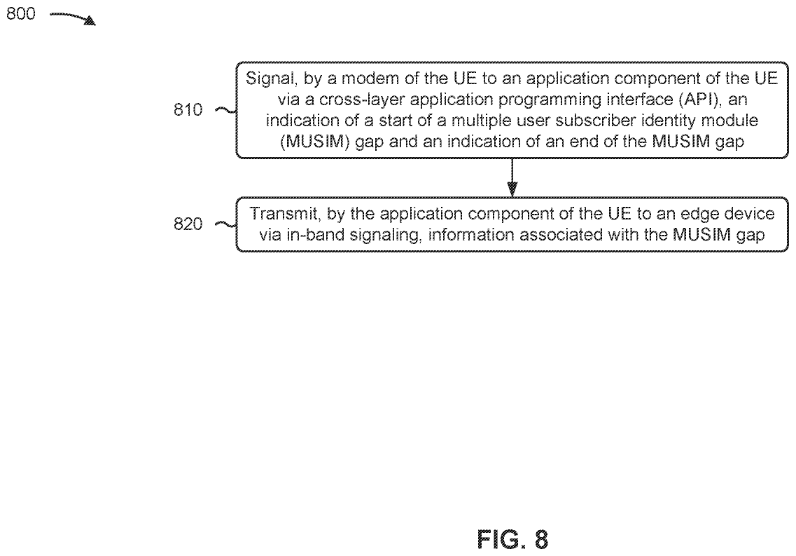

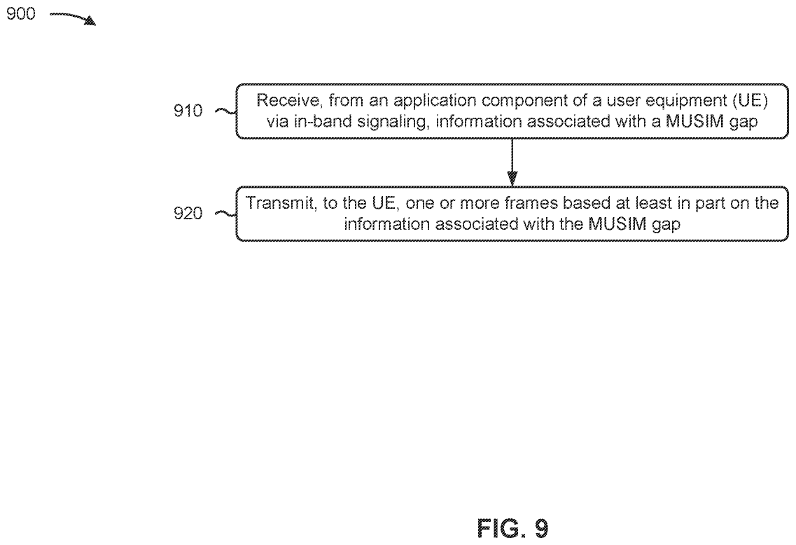

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with MUSIM gap signaling, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for signaling, by a modem of the UE 120 to an application component of the UE 120 via a cross-layer API, an indication of a start of a MUSIM gap and an indication of an end of the MUSIM gap; and/or means for transmitting, by the application component of the UE 120 to an edge device via in-band signaling, information associated with the MUSIM gap. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the edge device 150 includes means for receiving, from an application component of a UE via in-band signaling, information associated with a MUSIM gap; and/or means for transmitting, to the UE, one or more frames based at least in part on the information associated with the MUSIM gap. In some aspects, the means for the edge device to perform operations described herein may include, for example, one or more of communication manager 160, transmit processor 220, TX MIMO processor 230, modem 232, antenna 234, MIMO detector 236, receive processor 238, controller/processor 240, memory 242, or scheduler 246.

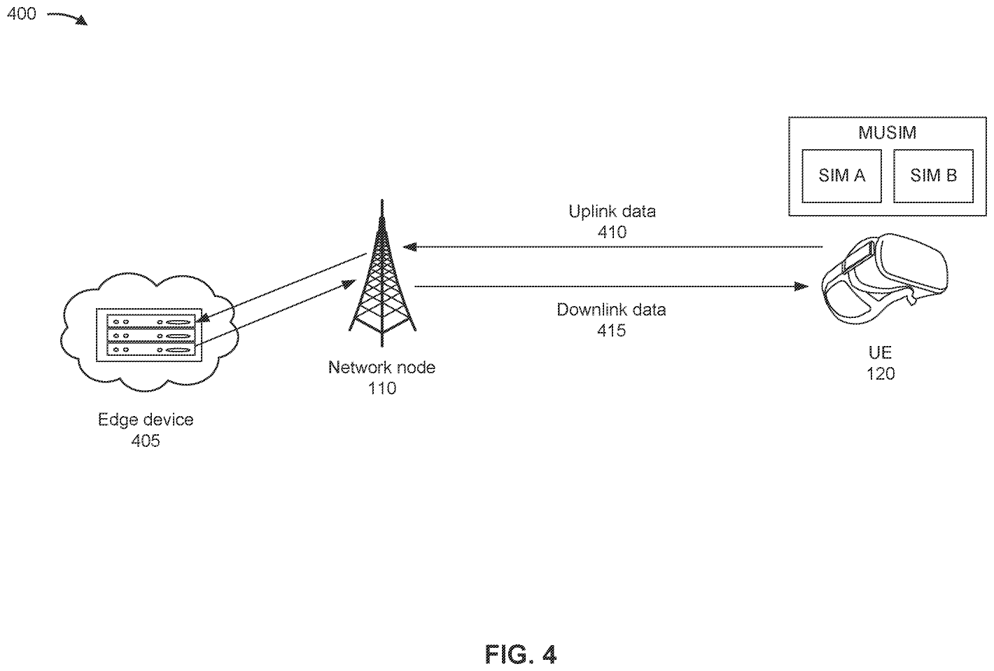

FIG. 4 is a diagram illustrating an example 400 of MUSIM enabled communications, in accordance with the present disclosure. The UE 120 may communicate with the network node 110. In some cases, the UE 120 may be an XR device, such as a VR headset with on-device processing. The network node 110 may communicate with an edge device 405. The edge device 405 may be (or may include) an application server associated with an application operating on the UE 120. In some examples, the edge device 405 may be the edge device 150 or may include one or more features of the edge device 150. The UE 120 may transmit, and the network node 110 may receive, uplink data 410. The uplink data 410 may be, for example, tracking data and/or input data. In one example, the UE 120 may transmit the uplink data 410 to the network node 110 at a rate of 100 bytes every 2 milliseconds (ms) (for example, at 500 hertz (Hz)). This may be changed (for example, reduced) to align with a video frame rate. The network node 110 may transmit the uplink data 410 to the edge device 405. The edge device 405 may generate downlink data 415 and may transmit the downlink data 415 to the network node 110. The edge device 405 may generate the downlink data 415 based at least in part on the uplink data 410. In one example, the downlink data 415 may include video data that is encoded at a rate of 45, 60, 75, or 90 frames per second (for example, every 11, 13, 16, or 22 ms). The network node 110 may transmit the downlink data 415 to the UE 120. In some cases, the downlink data 415 may be quasi-periodic encoded video data with a burst every frame (at one frame-per-second (fps)) or with two staggered “eye-buffers” per frame (at two fps). Pose and controller traffic associated with the uplink data 410 may be used by the edge device 405 (for example, the application server) for downlink traffic generation. The user experience may be based at least in part on a round-trip time (RTT) between the pose/controller traffic associated with the uplink data 410 and the corresponding downlink frame packets (and may be, for example, less than 20 ms).

The UE 120 may communicate using MUSIM communications. For example, the UE 120 may communicate with a first network (and/or first MNO) using a first SIM (for example, SIM A) and may communicate with a second network (and/or second MNO) using a second SIM (for example, SIM B). However, the UE 120 may only communicate using a single network at a given time. For example, a UE that is connected to the first network using SIM A may need to switch to the second network prior to communicating on the second network using SIM B. Additionally, there may not be any coordination between the networks and mobile network operators. For example, the first network and the second network may not be able to coordinate handovers associated with the UE 120. In some examples, the UE 120 may need to be able to receive an MT call in one network (for example, the second network) while being in an RRC connected state in another network (for example, the first network). Additionally, the UE 120 may need to be able to receive paging in both networks while the UE 120 is in an RRC idle state (for example, with respect to both networks). Further, when receiving a paging message in the second network while being RRC connected to the first network, the UE 120 may need to be able to notify the first network that the UE 120 is to leave the first network (for example, to answer the paging in the second network).

The UE 120 may be configured with one or more MUSIM gaps. A MUSIM gap may be a period of time during which the UE 120 suspends operations in a network. For example, a UE 120 that is RRC connected in the first network may not perform any communications in the first network during a MUSIM gap that occurs in the first network. The UE 120 may be RRC configured with up to three periodic MUSIM gaps and a single aperiodic (for example, one-shot) MUSIM gap. The periodic MUSIM gaps may be for cell measurements, SI reception, and paging monitoring, and the aperiodic MUSIM gaps may be for on-demand SI requests (for example, associated with a RACH procedure). In some cases, the UE 120 may report one or more preferences regarding the quantity of MUSIM gaps and associated MUSIM gap configurations via a UE assistance information message. In some examples, to be able to receive paging in the second network while being RRC connected to the first network, the UE 120 may need to perform cell identification, selection, and reselection, SIB acquisition, on-demand SIB request(s), and paging monitoring in the second network. In some cases, a MUSIM gap in the first network may interrupt services that are ongoing in the first network. For example, a MUSIM gap may result in the UE 120 failing to receive uplink data (and/or failing to transmit downlink data), which may increase latency and/or otherwise disrupt the user experience.

As indicated above, FIG. 4 is provided as an example. Other examples may differ from what is described with regard to FIG. 4.

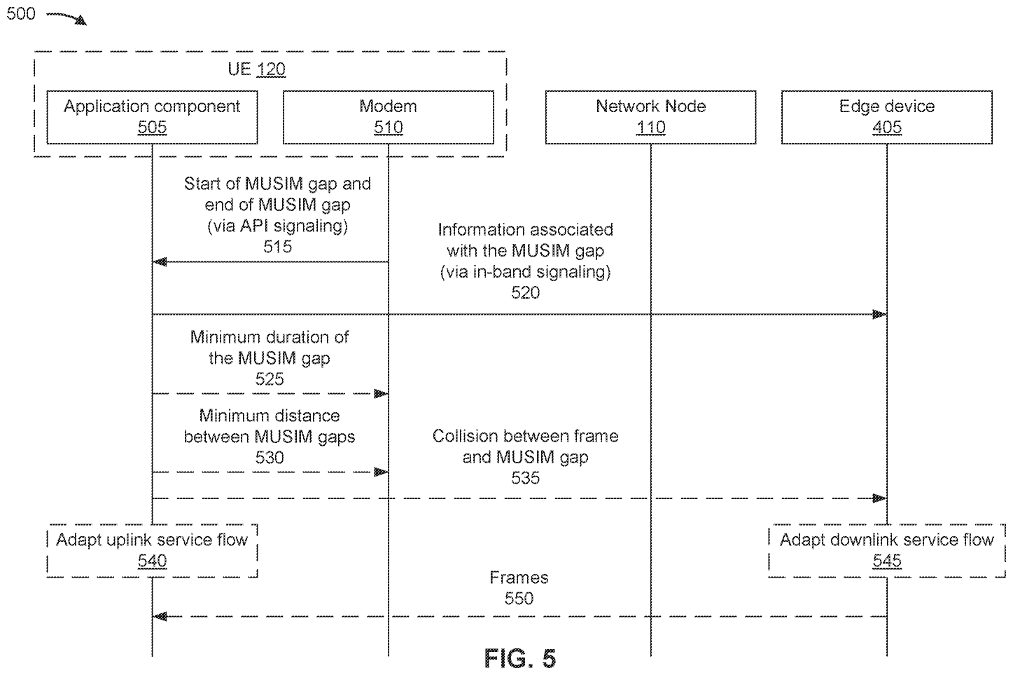

FIG. 5 is a diagram illustrating an example 500 of MUSIM gap signaling, in accordance with the present disclosure. The UE 120 may communicate with the network node 110 and the edge device 405. The UE 120 may include an application component 505 (for example, an application client operating on the UE 120) and a modem 510.

As shown by reference number 515, the modem 510 may signal, to the application component 505, an indication of a start of a MUSIM gap and an indication of an end of the MUSIM gap. The modem 510 may signal the indication of the start of the MUSIM gap and the indication of the end of the MUSIM gap using an application programming interface (API) such as a cross-layer API. In some aspects, the indication of the end of the MUSIM gap may be an indication of a duration of the MUSIM gap. For example, signaling the indication of the start of the MUSIM gap and the indication of the end of the MUSIM gap may include signaling the indication of the start of the MUSIM gap and an indication of the duration of the MUSIM gap.

As shown by reference number 520, the application component 505 may transmit, and the edge device 405 may receive, information associated with the MUSIM gap. The application component 505 may transmit the information associated with the MUSIM gap using in-band signaling. In some aspects, the information associated with the MUSIM gap may include the indication of the start of the MUSIM gap and the indication of the end of the MUSIM gap. In some other aspects, the information associated with the MUSIM gap may include the indication of the start of the MUSIM gap and the indication of the duration of the MUSIM gap. In some aspects, the information associated with the MUSIM gap may include an indication of an availability of a radio link associated with the MUSIM gap.

As shown by reference number 525, the application component 505 may signal, to the modem 510, a minimum duration of the MUSIM gap. The application component 505 may signal the minimum duration of the MUSIM gap prior to the modem 510 signaling the indication of the start of the MUSIM gap and the indication of the end of the MUSIM gap. For example, the modem 510 may receive the minimum duration of the MUSIM gap and may signal, to the application component 505, the indication of the start of the MUSIM gap and the indication of the end of the MUSIM gap based at least in part on the minimum duration of the MUSIM gap. In some aspects, the modem 510 may not signal (for example, may refrain from signaling) information associated with a MUSIM gap having a duration that is less than the minimum duration. For example, the application component 505 may signal, to the modem 510, an indication of a minimum duration of 10 ms for a MUSIM gap. The modem 510 may transmit, to the application component 505, information associated with a MUSIM gap in accordance with the MUSIM gap having a duration that is greater than or equal to 10 ms. Alternatively, the modem 510 may refrain from transmitting information associated with a MUSIM gap in accordance with the MUSIM gap having a duration that is less than 10 ms. In some examples, the MUSIM gap may be between 3 ms and 20 ms.

As shown by reference number 530, the application component 505 may signal, to the modem 510, a minimum distance between MUSIM gaps. In some examples, the UE 120 may be configured with up to three periodic MUSIM gaps and/or may be configured with a single aperiodic MUSIM gap. Service updates that occur with a frequency that is too high may interrupt the user experience. In some aspects, if the distance between an end of a MUSIM gap and a start of a subsequent MUSIM gap is less than the minimum distance, the modem 510 may process both MUSIM gaps as a single MUSIM gap (for example, a combined MUSIM gap). A duration of the single MUSIM gap may be equal to a sum of the duration of the MUSIM gap, a duration of the subsequent MUSIM gap, and a duration between the MUSIM gap and the subsequent MUSIM gap. In one example, the application component 505 may signal a minimum distance of 10 ms between MUSIM gaps. The modem 510 may detect a MUSIM gap having a duration of 4 ms, a subsequent MUSIM gap having a duration of 4 ms, and a duration between the MUSIM gap and the subsequent MUSIM gap of 8 ms. Since the duration between the MUSIM gap and the subsequent MUSIM gap is less than 10 ms, the modem 510 may process the MUSIM gap and the subsequent MUSIM gap as a single MUSIM gap having a duration of 16 ms (for example, beginning at the start of the MUSIM gap and ending at the end of the subsequent MUSIM gap).

As shown by reference number 535, the application component 505 may transmit, and the edge device 405 may receive, an indication of a collision between a frame and the MUSIM gap. In some aspects, the application component 505 may transmit the indication of the collision between the frame and the MUSIM gap without receiving the indication of the start of the MUSIM gap and the indication of the end of the MUSIM gap (and/or the indication of the duration of the MUSIM gap). For example, instead of signaling the indication of the start of the MUSIM gap and the indication of the end of the MUSIM gap, the application component 505 may identify (for example, predict) if an upcoming downlink frame is going to collide with the MUSIM gap. The application component 505 may perform the prediction in accordance with an arrival pattern of one or more previous downlink frames associated with an application that is operating on the UE 120. In some aspects, the application component 505 may signal, to the edge device 405 via in-band signaling, that one or more future downlink frames are to collide with a subsequent MUSIM gap. The signaling (for example, report) may include a frame identifier of a first frame of the one or more future downlink frames that are to collide with the subsequent MUSIM gap and/or may indicate a quantity of consecutive downlink frames of the one or more future downlink frames that are to collide with the subsequent MUSIM gap.

In some aspects, when notified of an upcoming MUSIM gap, the application component 505 and/or the edge device 405 may perform one or more actions to minimize an impact on the user experience.

As shown by reference number 540, the application component 505 may adapt (for example, apply) an uplink service flow. The application component 505 may adapt the uplink service flow based at least in part on receiving the information associated with the MUSIM gap from the modem 510. The uplink service flow may be based at least in part on the information associated with the MUSIM gap, such as the indication of the start of the MUSIM gap and the indication of the end of the MUSIM gap (and/or the indication of the duration of the MUSIM gap).

As shown by reference number 545, the edge device 405 may adapt (for example, apply) a downlink service flow. The edge device 405 may adapt the downlink service flow based at least in part on receiving the information associated with the MUSIM gap from the application component 505. The downlink service flow may be based at least in part on the information associated with the MUSIM gap, such as the indication of the start of the MUSIM gap and the indication of the end of the MUSIM gap (and/or the indication of the duration of the MUSIM gap).

In some examples, adapting the uplink service flow and/or adapting the downlink service flow (for example, for video frames) may include performing a frame blanking during the MUSIM gap, performing a (proactive) intra-coded frame (I-frame) insertion after the MUSIM gap, performing a predicted frame (P-frame) insertion after the MUSIM gap (where the P-frame insertion after the MUSIM gap is predicted from a P-frame that is before the MUSIM gap), and/or performing a gradual decoding refresh operation (for example, with a first frame after a gap that is refreshed from a last frame before the gap).

As shown by reference number 550, the edge device 405 may transmit, and the application component 505 may receive, one or more frames based at least in part on the information associated with the MUSIM gap. For example, the edge device 405 may transmit one or more frames associated with an application in accordance with the downlink service flow.

As indicated above, FIG. 5 is provided as an example. Other examples may differ from what is described with regard to FIG. 5.

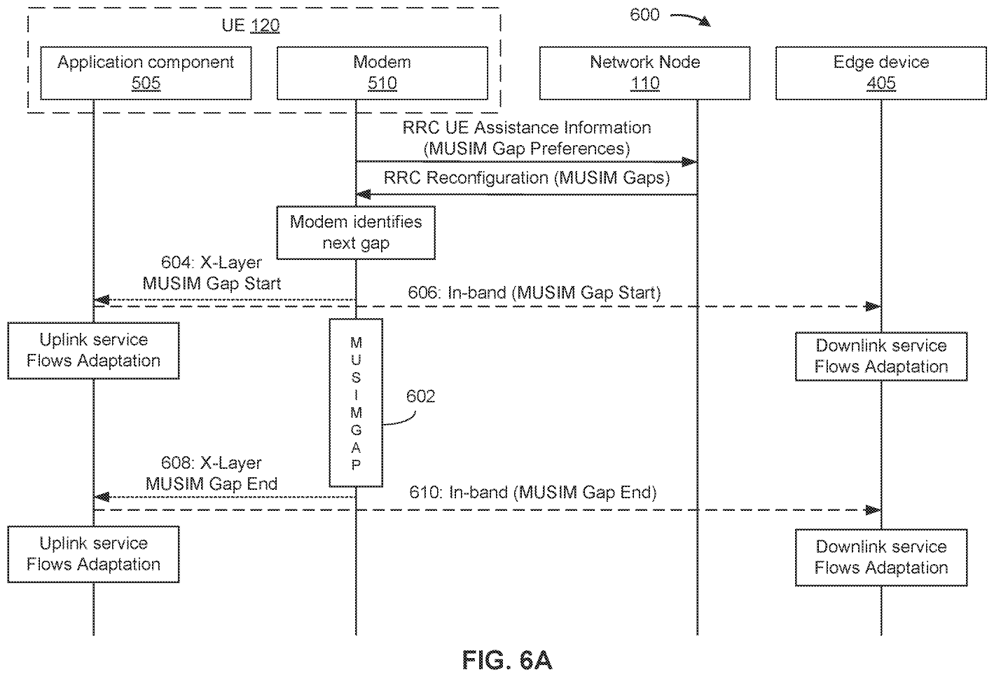

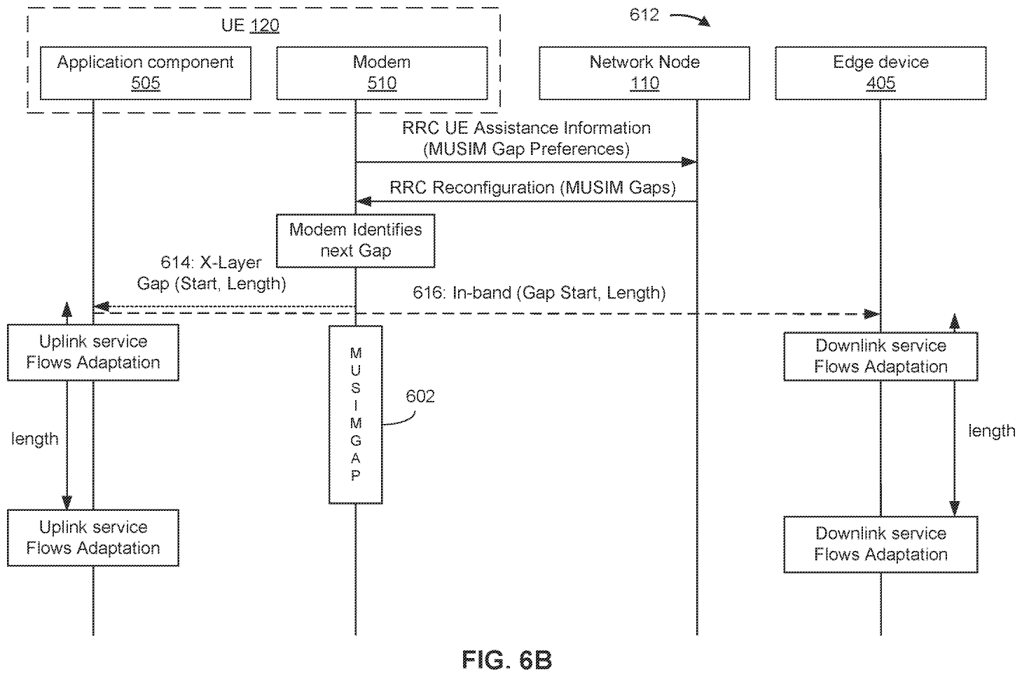

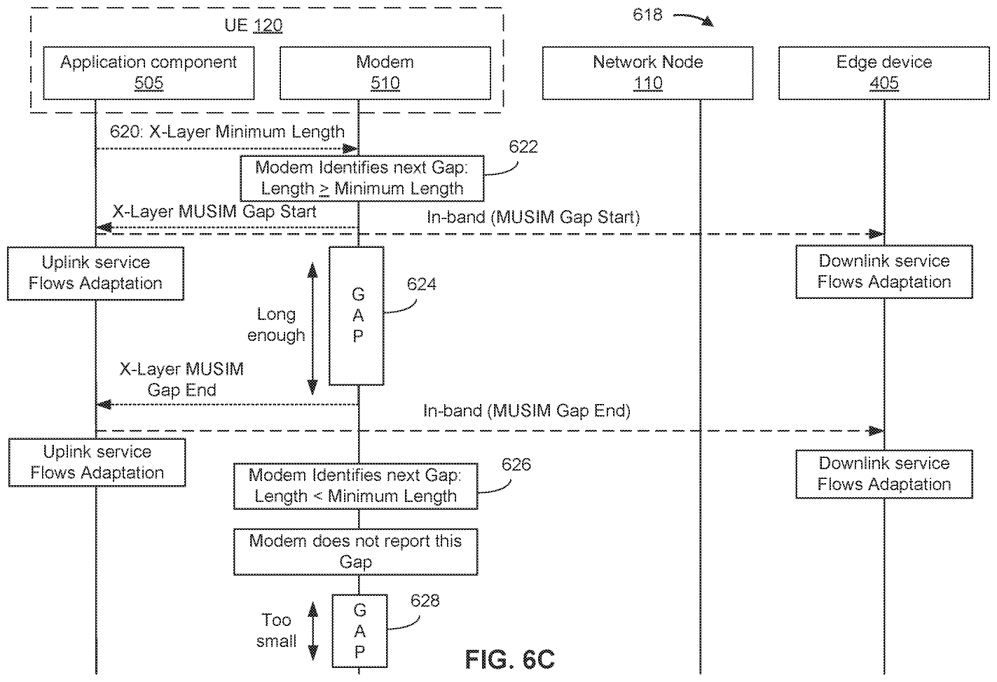

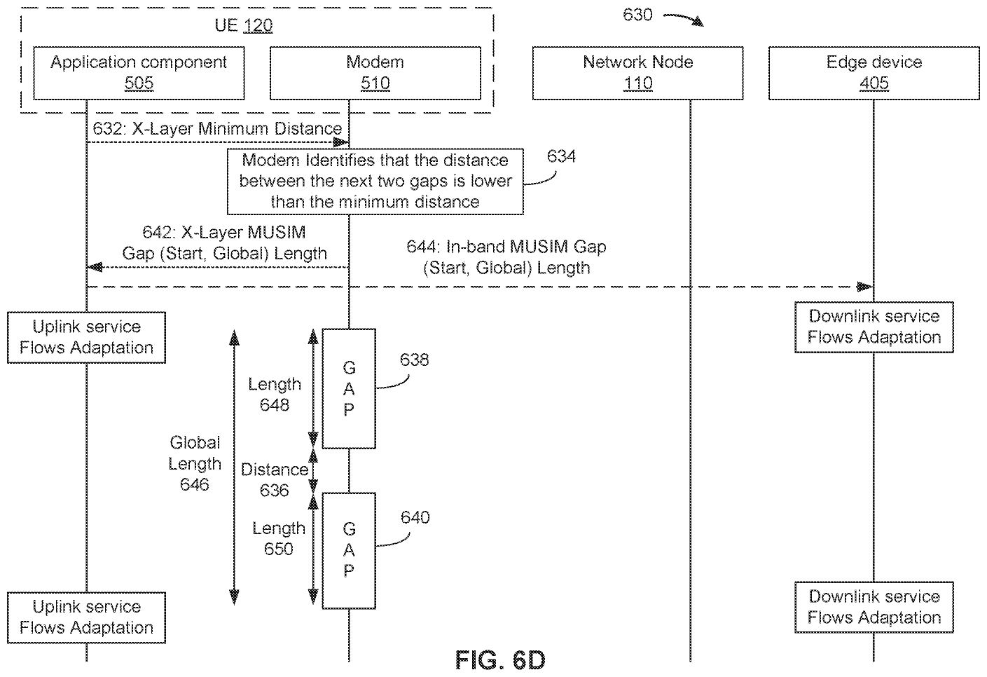

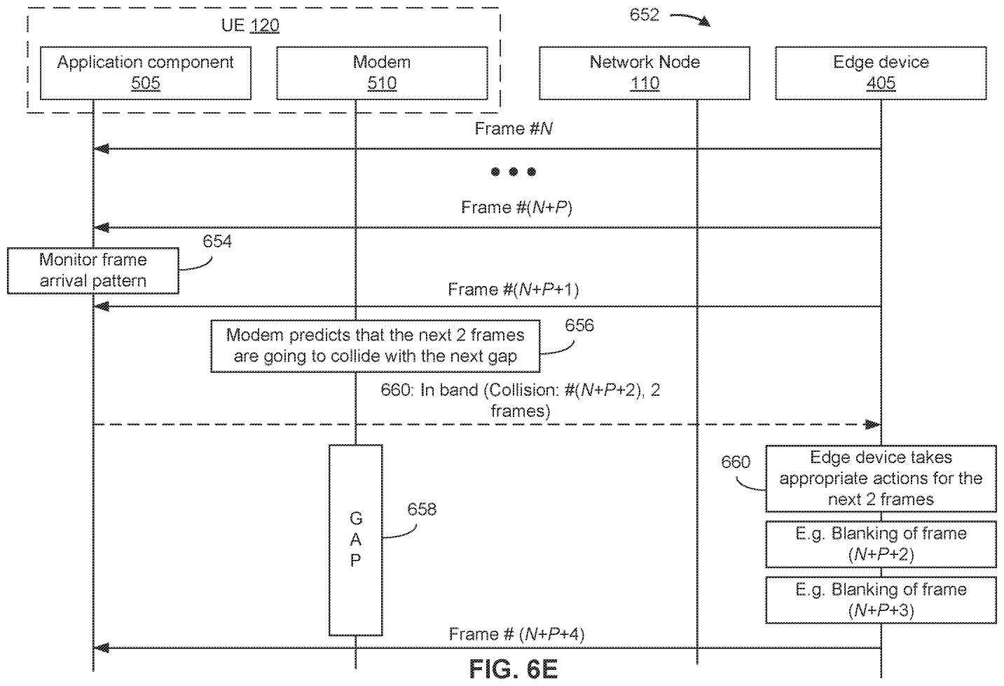

FIGS. 6A-6E are diagrams illustrating examples of MUSIM gap signaling, in accordance with the present disclosure.

As shown in FIG. 6A and example 600, the modem 510 may transmit, to the network node 110, RRC signaling that includes UE assistance information (such as MUSIM gap preference information). The network node 110 may transmit an RRC configuration (or reconfiguration) for MUSIM gaps that is based at least in part on the MUSIM gap preference information. The modem 510 may identify a next MUSIM gap. For example, the modem 510 may identify MUSIM gap 602. As shown by reference number 604, the modem 510 may signal, to the application component 505, a MUSIM gap start indication that indicates a start of the MUSIM gap 602. Signaling the MUSIM gap start indication may include signaling a cross-layer (shown as X-layer) MUSIM gap start indication. As shown by reference number 606, the application component 505 may transmit, and the edge device 405 may receive, an in-band MUSIM gap start indication. As shown by reference number 608, the application component 505 may signal, to the application component 505, a MUSIM gap end indication (for example, an X-layer MUSIM gap end indication) that indicates an end of the MUSIM gap 602. As shown by reference number 610, the application component 505 may transmit, and the edge device 405 may receive, an in-band MUSIM gap end indication. The application component 505 may adapt an uplink service flow based at least in part on the MUSIM gap start indication and/or the MUSIM gap end indication. Additionally, or alternatively, the edge device 405 may adapt a downlink service flow based at least in part on the MUSIM gap start indication and/or the MUSIM gap end indication.

As shown in FIG. 6B and example 612, the modem 510 may transmit, to the network node 110, RRC signaling that includes UE assistance information (such as MUSIM gap preference information). The network node 110 may transmit an RRC configuration (or reconfiguration) for MUSIM gaps that is based at least in part on the MUSIM gap preference information. The modem 510 may identify a next MUSIM gap. For example, the modem 510 may identify the MUSIM gap 602. As shown by reference number 614, the modem 510 may signal, to the application component 505, a MUSIM gap (start, length) indication (for example, an X-layer gap (start, length) indication) that indicates a start of the MUSIM gap 602 and a length (for example, duration) of the MUSIM gap 602. As shown by reference number 616, the application component 505 may transmit, and the edge device 405 may receive, an in-band MUSIM gap (start, length) indication. The application component 505 may adapt an uplink service flow based at least in part on the MUSIM gap (start, length) indication. Additionally, or alternatively, the edge device 405 may adapt a downlink service flow based at least in part on the MUSIM gap (start, length) indication.

As shown in FIG. 6C and example 618, the application component 505 may signal, to the modem 510, an indication of a minimum length (duration) for a MUSIM gap. For example, as shown by reference number 620, the application component 505 may signal, to the modem 510, an X-layer minimum length indication for a MUSIM gap. As shown by reference number 622, the modem 510 may identify that a next MUSIM gap (shown as gap 624) has a length that is greater than or equal to the minimum length. The modem 510 may signal, to the application component 505, an X-layer MUSIM gap start indication associated with the gap 624. Additionally, the application component 505 may transmit, to the edge device 405, an in-band signal that indicates the MUSIM gap start. After an end of the gap 624, the modem 510 may signal, to the application component 505, an indication of an X-layer MUSIM gap end indication associated with the gap 624. Additionally, the application component 505 may transmit, to the edge device 405, an in-band signal that indicates the MUSIM gap end. As shown by reference number 626, the modem 510 may identify that a next MUSIM gap (shown as gap 628) has a length that is less than the minimum length. The modem 510 may refrain from reporting the gap 628 to the application component 505 based at least in part on the gap 628 having a length that is less than the minimum length.

As shown in FIG. 6D and example 630, the application component 505 may signal, to the modem 510, an indication of a minimum distance between MUSIM gaps. For example, as shown by reference number 632, the application component 505 may signal, to the modem 510, an X-layer minimum distance indication that indicates a minimum distance between MUSIM gaps. As shown by reference number 634, the modem 510 may identify that a distance 636 between a gap 638 and a gap 640 is lower than the minimum distance. As shown by reference number 642, the modem 510 may signal, to the application component 505, an X-layer MUSIM gap (start, global) length indication. As shown by reference number 644, the application component 505 may transmit, and the edge device 405 may receive, an in-band signal that includes the MUSIM gap (start, global) length indication. The MUSIM gap (start, global) length indication may indicate a start of the MUSIM gap 638 and a global length 646. The global length 646 may be a sum of a length 648 associated with the gap 638, the distance 636, and a length 650 associated with the gap 640. For example, the global length 646 may have a duration that spans from a start of the gap 638 to an end of the gap 640.

As shown in FIG. 6E and example 652, the edge device 405 may transmit, and the application component 505 may receive, one or more frames. For example, the edge device 405 may transmit frame #N and frame #(N+P). As shown by reference number 654, the application component 505 may monitor a frame arrival pattern. The edge device 405 may transmit, and the application component 505 may receive, frame #(N+P+1). As shown by reference number 656, the modem 510 may predict that a next two frames are going to collide with the next MUSIM gap (shown as gap 658). As shown by reference number 660, the application component 505 may transmit, and the edge device 405 may receive, an in-band signal that indicates the collision between the gap 658 and the next two frames. For example, the application component 505 may transmit an in-band collision indication (collision: #(N+P+2), 2 frames) indicating that the gap 658 is going to collide with the next two frames starting at frame #(N+P+2). As shown by reference number 660, the edge device 405 may take appropriate actions for the next two frames. For example, the edge device 405 may perform a blanking of frame #(N+P+2) and/or may perform a blanking of frame #(N+P+3). After frame #(N+P+3), the edge device 405 may transmit, and the application component 505 may receive, frame #(N+P+4).

As indicated above, FIGS. 6A-6E are provided as examples. Other examples may differ from what is described with regard to FIGS. 6A-6E.

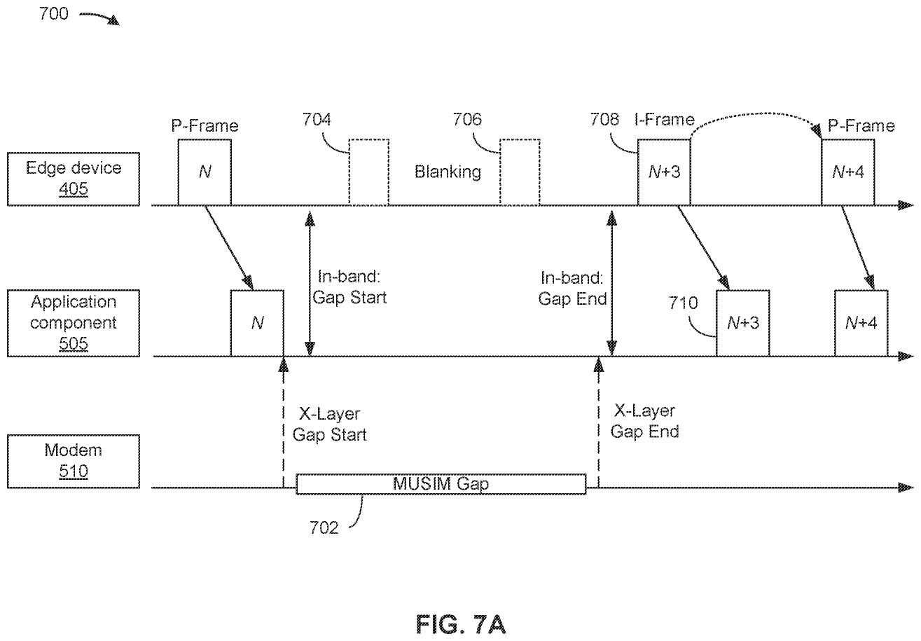

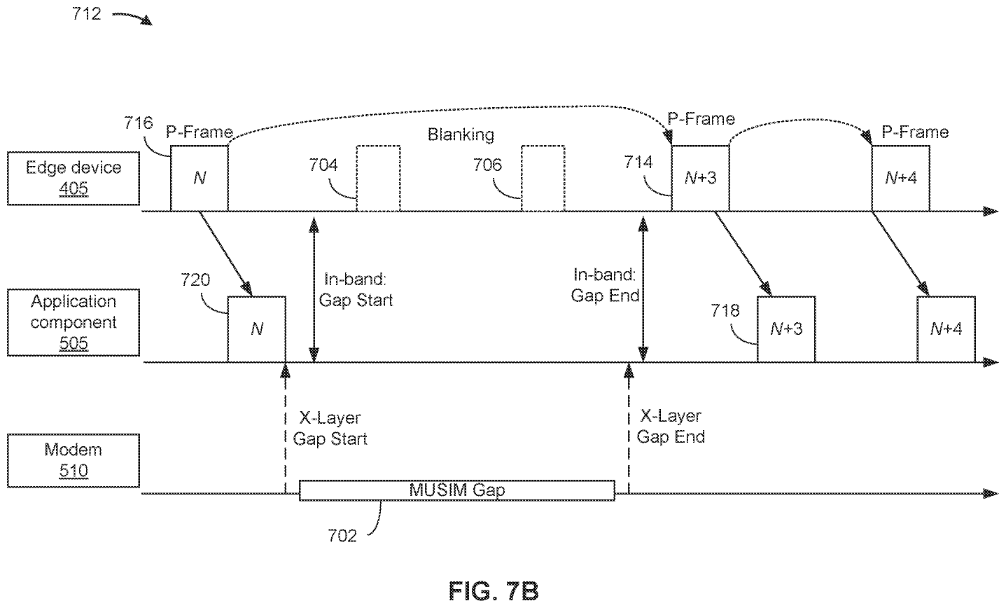

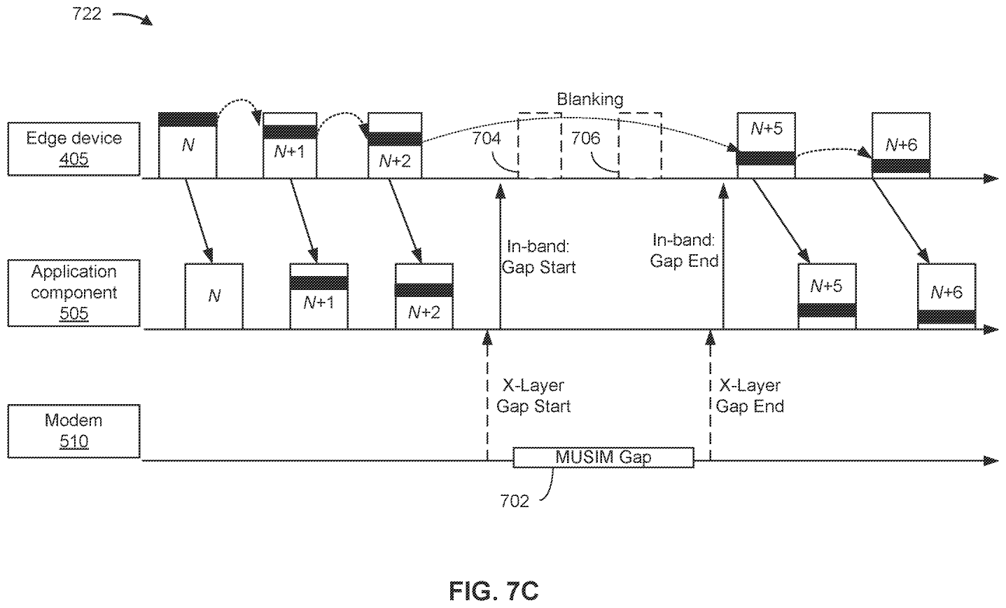

FIGS. 7A-7C are diagrams illustrating examples of service adaptation from MUSIM gap signaling, in accordance with the present disclosure.

The application component 505 and/or the edge device 405 may perform one or more actions when notified of an upcoming MUSIM gap, for example, to minimize an impact on the user experience. In some aspects, as described above in connection with FIG. 5, the application component 505 may adapt (for example, apply) an uplink service flow. The application component 505 may adapt the uplink service flow based at least in part on receiving the information associated with the MUSIM gap from the modem 510. The uplink service flow may be based at least in part on the information associated with the MUSIM gap, such as the indication of the start of the MUSIM gap and the indication of the end of the MUSIM gap. Additionally, or alternatively, the edge device 405 may adapt (for example, apply) a downlink service flow. The edge device 405 may adapt the downlink service flow based at least in part on receiving the information associated with the MUSIM gap from the application component 505. The downlink service flow may be based at least in part on the information associated with the MUSIM gap, such as the indication of the start of the MUSIM gap and the indication of the end of the MUSIM gap.

The modem 510 may identify a MUSIM gap 702. As described above in connection with FIG. 5, the modem 510 may signal (via cross-layer API signaling), to the application component 505, an indication of a start of the MUSIM gap 702 and an indication of an end of the MUSIM gap 702. The application component 505 may transmit, to the edge device 405 via in-band signaling, the indication of the start of the MUSIM gap 702 and the indication of the end of the MUSIM gap 702.

As shown in FIG. 7A and example 700, the edge device 405 may perform blanking and proactive I-frame insertion. For example, the edge device 405 may perform blanking for a frame 704 and a frame 706 that occur during the MUSIM gap 702. Additionally, the edge device 405 may insert an I-frame 708 at a frame location N+3 that occurs after the MUSIM gap 702. The application component 505, based at least in part on in-band signaling from the edge device 405, may receive an I-frame 710 at the frame location N+3 that occurs after the MUSIM gap 702.

As shown in FIG. 7B and example 712, the edge device 405 may perform blanking and P-frame insertion before the MUSIM gap. For example, the edge device 405 may perform blanking for a frame 704 and a frame 706 that occur during the MUSIM gap 702. Additionally, the edge device 405 may insert a P-Frame 714 at a frame location N+3 that occurs after the MUSIM gap 702. The P-frame 714 may correspond to another P-frame 716 at frame location N that occurs before the MUSIM gap 702. The application component 505, based at least in part on in-band signaling from the edge device 405, may receive a P-frame 718 at the frame location N+3 that occurs after the MUSIM gap 702. The P-frame 718 may be based at least in part on another P-frame 720 at frame location N that occurs before the MUSIM gap 702.

As shown in FIG. 7C and example 722, the edge device 405 may perform blanking and gradual decoding refresh. For example, the edge device 405 may perform blanking for a frame 704 and a frame 706 that occur during the MUSIM gap 702. Additionally, the edge device 405 may perform a gradual decoding refresh for a remainder of the frames, such as frames N, N+1, and N+2 that occur before the MUSIM gap 702, and frames N+5 and N+6 that occur after the MUSIM gap 702. Further, the application component 505, based at least in part on in-band signaling from the edge device 405, may perform the gradual decoding refresh for the remainder of the frames, such as frames N, N+1, and N+2 that occur before the MUSIM gap 702 and frames N+5 and N+6 that occur after the MUSIM gap 702.

As indicated above, FIGS. 7A-7C are provided as examples. Other examples may differ from what is described with regard to FIGS. 7A-7C.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with MUSIM gap signaling.

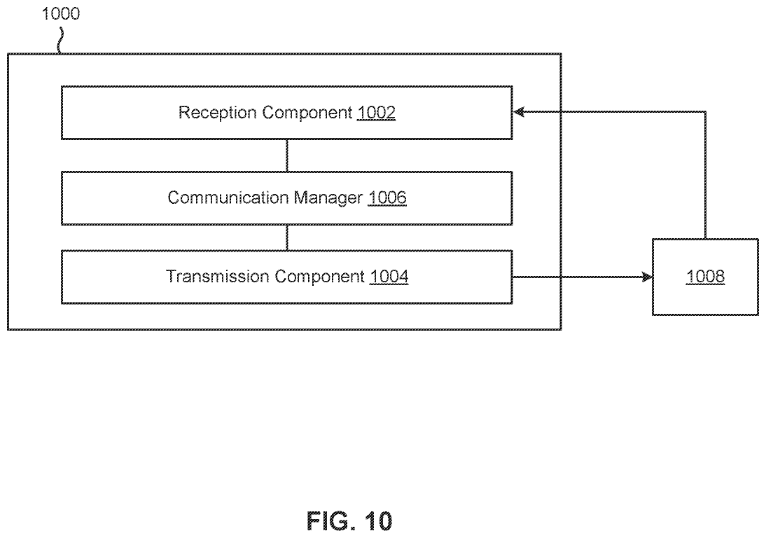

As shown in FIG. 8, in some aspects, process 800 may include signaling an indication of a start of a MUSIM gap and an indication of an end of the MUSIM gap (block 810). For example, a modem of the UE (e.g., using communication manager 1006, depicted in FIG. 10) may signal, to an application component of the UE via a cross-layer API, an indication of a start of a MUSIM gap and an indication of an end of the MUSIM gap, as described above.

As further shown in FIG. 8, in some aspects, process 800 may include transmitting information associated with the MUSIM gap (block 820). For example, the application component of the UE (e.g., using transmission component 1004 and/or communication manager 1006, depicted in FIG. 10) may transmit, via in-band signaling, information associated with the MUSIM gap, as described above.

Process 800 may include additional aspects, such as any single aspect or any combination of aspects described below and/or in connection with one or more other processes described elsewhere herein.

In a first aspect, transmitting the information associated with the MUSIM gap comprises transmitting, by the application component of the UE to the edge device via in-band signaling, the indication of the start of the MUSIM gap and the indication of the end of the MUSIM gap.

In a second aspect, alone or in combination with the first aspect, transmitting the information associated with the MUSIM gap comprises transmitting, by the application component of the UE to the edge device via in-band signaling, an indication of an availability of a radio link for communications that include the MUSIM gap.

In a third aspect, alone or in combination with one or more of the first and second aspects, the indication of the end of the MUSIM gap is an indication of a duration of the MUSIM gap.

In a fourth aspect, alone or in combination with one or more of the first through third aspects, process 800 includes signaling, by the application component of the UE to the modem of the UE, an indication of a minimum duration of the MUSIM gap, wherein the indication of the start of the MUSIM gap and the indication of the end of the MUSIM gap are based at least in part on the indication of the minimum duration of the MUSIM gap.

In a fifth aspect, alone or in combination with one or more of the first through fourth aspects, process 800 includes signaling, by the application component of the UE to the modem of the UE, an indication of a minimum distance between the MUSIM gap and a subsequent MUSIM gap.

In a sixth aspect, alone or in combination with one or more of the first through fifth aspects, the minimum distance between the MUSIM gap and the subsequent MUSIM gap is a minimum distance between an end of the MUSIM gap and a start of the subsequent MUSIM gap.

In a seventh aspect, alone or in combination with one or more of the first through sixth aspects, process 800 includes processing, by the modem of the UE, the MUSIM gap and the subsequent MUSIM gap as a single MUSIM gap based at least in part on a distance between the MUSIM gap and the subsequent MUSIM gap being less than the minimum distance.

In an eighth aspect, alone or in combination with one or more of the first through seventh aspects, a duration of the single MUSIM gap is equal to a sum of a duration of the MUSIM gap, a duration of the subsequent MUSIM gap, and a duration between the MUSIM gap and the subsequent MUSIM gap.

In a ninth aspect, alone or in combination with one or more of the first through eighth aspects, transmitting the information associated with the MUSIM gap comprises transmitting, by the application component of the UE to the edge device via in-band signaling, an indication that one or more downlink frames are to collide with the MUSIM gap.

In a tenth aspect, alone or in combination with one or more of the first through ninth aspects, the indication that the one or more downlink frames are to collide with the MUSIM gap includes at least one of a frame identifier of a first downlink frame of the one or more downlink frames and a quantity of frames included in the one or more downlink frames.

In an eleventh aspect, alone or in combination with one or more of the first through tenth aspects, process 800 includes identifying the one or more downlink frames based at least in part on an arrival pattern of one or more other downlink frames received by the UE prior to the one or more downlink frames.

In a twelfth aspect, alone or in combination with one or more of the first through eleventh aspects, process 800 includes applying, by the application component of the UE, an uplink service flow that is based at least in part on the information associated with the MUSIM gap.

In a thirteenth aspect, alone or in combination with one or more of the first through twelfth aspects, applying the uplink service flow comprises performing at least one of a frame blanking during the MUSIM gap, an intra-coded frame insertion after the MUSIM gap, a predicted frame insertion after the MUSIM gap, or a gradual decoding refresh operation.

In a fourteenth aspect, alone or in combination with one or more of the first through thirteenth aspects, the UE is an extended reality device that includes the modem and the application component.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at an edge device or an apparatus of an edge device, in accordance with the present disclosure. Example process 900 is an example where the apparatus or the edge device (e.g., edge device 150 and/or edge device 405) performs operations associated with MUSIM gap signaling.

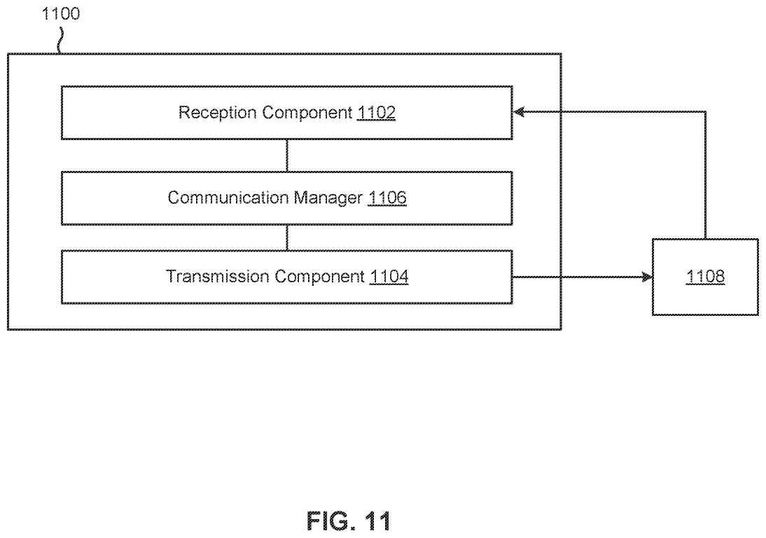

As shown in FIG. 9, in some aspects, process 900 may include receiving, from an application component of a UE via in-band signaling, information associated with a MUSIM gap (block 910). For example, the edge device (e.g., using reception component 1102 and/or communication manager 1106, depicted in FIG. 11) may receive, from an application component of a UE via in-band signaling, information associated with a MUSIM gap, as described above.

As further shown in FIG. 9, in some aspects, process 900 may include transmitting, to the UE, one or more frames based at least in part on the information associated with the MUSIM gap (block 920). For example, the edge device (e.g., using transmission component 1104 and/or communication manager 1106, depicted in FIG. 11) may transmit, to the UE, one or more frames based at least in part on the information associated with the MUSIM gap, as described above.

Process 900 may include additional aspects, such as any single aspect or any combination of aspects described below and/or in connection with one or more other processes described elsewhere herein.

In a first aspect, receiving the information associated with the MUSIM gap comprises receiving, from the application component of the UE via in-band signaling, an indication of a start of the MUSIM gap and an indication of an end of the MUSIM gap.

In a second aspect, alone or in combination with the first aspect, receiving the information associated with the MUSIM gap comprises receiving, from the application component of the UE via in-band signaling, an indication of an availability of a radio link for communications that include the MUSIM gap.

In a third aspect, alone or in combination with one or more of the first and second aspects, receiving the information associated with the MUSIM gap comprises receiving, from the application component of the UE via in-band signaling, an indication of a start of the MUSIM gap and an indication of a duration of the MUSIM gap.

In a fourth aspect, alone or in combination with one or more of the first through third aspects, receiving the information associated with the MUSIM gap comprises receiving, from the application component of the UE via in-band signaling, an indication that one or more downlink frames are to collide with the MUSIM gap.

In a fifth aspect, alone or in combination with one or more of the first through fourth aspects, the indication that the one or more downlink frames are to collide with the MUSIM gap includes at least one of a frame identifier of a first downlink frame of the one or more downlink frames and a quantity of frames included in the one or more downlink frames.

In a sixth aspect, alone or in combination with one or more of the first through fifth aspects, process 900 includes applying a downlink service flow that is based at least in part on the information associated with the MUSIM gap.

In a seventh aspect, alone or in combination with one or more of the first through sixth aspects, applying the downlink service flow comprises performing at least one of a frame blanking during the MUSIM gap, an intra-coded frame insertion after the MUSIM gap, a predicted frame insertion after the MUSIM gap, or a gradual decoding refresh operation.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5, 6A, 6B, 6C, 6D, 6E, 7A, 7B, and/or 7C. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may signal an indication of a start of a MUSIM gap and an indication of an end of the MUSIM gap. The transmission component 1004 may transmit information associated with the MUSIM gap. The transmission component 1004 may transmit an indication of a minimum duration of the MUSIM gap, wherein the indication of the start of the MUSIM gap and the indication of the end of the MUSIM gap are based at least in part on the indication of the minimum duration of the MUSIM gap. The transmission component 1004 may transmit an indication of a minimum distance between the MUSIM gap and a subsequent MUSIM gap. The communication manager 1006 may process the MUSIM gap and the subsequent MUSIM gap as a single MUSIM gap based at least in part on a distance between the MUSIM gap and the subsequent MUSIM gap being less than the minimum distance. The communication manager 1006 may identify the one or more downlink frames based at least in part on an arrival pattern of one or more other downlink frames received by the UE prior to the one or more downlink frames. The communication manager 1006 may apply an uplink service flow that is based at least in part on the information associated with the MUSIM gap.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be an edge device, or an edge device may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 160 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5, 6A, 6B, 6C, 6D, 6E, 7A, 7B, and/or 7C. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the edge device described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the edge device described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the edge device described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from an application component of a UE via in-band signaling, information associated with a MUSIM gap. The transmission component 1104 may transmit, to the UE, one or more frames based at least in part on the information associated with the MUSIM gap. The communication manager 1106 may apply a downlink service flow that is based at least in part on the information associated with the MUSIM gap.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: signaling, by a modem of the UE to an application component of the UE via a cross-layer application programming interface (API), an indication of a start of a multiple user subscriber identity module (MUSIM) gap and an indication of an end of the MUSIM gap; and transmitting, by the application component of the UE to an edge device via in-band signaling, information associated with the MUSIM gap.

Aspect 2: The method of Aspect 1, wherein transmitting the information associated with the MUSIM gap comprises transmitting, by the application component of the UE to the edge device via in-band signaling, the indication of the start of the MUSIM gap and the indication of the end of the MUSIM gap.

Aspect 3: The method of any of Aspects 1-2, wherein transmitting the information associated with the MUSIM gap comprises transmitting, by the application component of the UE to the edge device via in-band signaling, an indication of an availability of a radio link for communications that include the MUSIM gap.

Aspect 4: The method of any of Aspects 1-3, wherein the indication of the end of the MUSIM gap is an indication of a duration of the MUSIM gap.

Aspect 5: The method of any of Aspects 1-4, further comprising signaling, by the application component of the UE to the modem of the UE, an indication of a minimum duration of the MUSIM gap, wherein the indication of the start of the MUSIM gap and the indication of the end of the MUSIM gap are based at least in part on the indication of the minimum duration of the MUSIM gap.

Aspect 6: The method of any of Aspects 1-5, further comprising signaling, by the application component of the UE to the modem of the UE, an indication of a minimum distance between the MUSIM gap and a subsequent MUSIM gap.

Aspect 7: The method of Aspect 6, wherein the minimum distance between the MUSIM gap and the subsequent MUSIM gap is a minimum distance between an end of the MUSIM gap and a start of the subsequent MUSIM gap.

Aspect 8: The method of Aspect 6, further comprising processing, by the modem of the UE, the MUSIM gap and the subsequent MUSIM gap as a single MUSIM gap based at least in part on a distance between the MUSIM gap and the subsequent MUSIM gap being less than the minimum distance.

Aspect 9: The method of Aspect 8, wherein a duration of the single MUSIM gap is equal to a sum of a duration of the MUSIM gap, a duration of the subsequent MUSIM gap, and a duration between the MUSIM gap and the subsequent MUSIM gap.

Aspect 10: The method of any of Aspects 1-9, wherein transmitting the information associated with the MUSIM gap comprises transmitting, by the application component of the UE to the edge device via in-band signaling, an indication that one or more downlink frames are to collide with the MUSIM gap.

Aspect 11: The method of Aspect 10, wherein the indication that the one or more downlink frames are to collide with the MUSIM gap includes at least one of a frame identifier of a first downlink frame of the one or more downlink frames and a quantity of frames included in the one or more downlink frames.

Aspect 12: The method of Aspect 10, further comprising identifying the one or more downlink frames based at least in part on an arrival pattern of one or more other downlink frames received by the UE prior to the one or more downlink frames.

Aspect 13: The method of any of Aspects 1-12, further comprising applying, by the application component of the UE, an uplink service flow that is based at least in part on the information associated with the MUSIM gap.

Aspect 14: The method of Aspect 13, wherein applying the uplink service flow comprises performing at least one of a frame blanking during the MUSIM gap, an intra-coded frame insertion after the MUSIM gap, a predicted frame insertion after the MUSIM gap, or a gradual decoding refresh operation.

Aspect 15: The method of any of Aspects 1-14, wherein the UE is an extended reality device that includes the modem and the application component.

Aspect 16: A method of wireless communication performed by an edge device, comprising: receiving, from an application component of a user equipment (UE) via in-band signaling, information associated with a multiple user subscriber identity module (MUSIM) gap; and transmitting, to the UE, one or more frames based at least in part on the information associated with the MUSIM gap.

Aspect 17: The method of Aspect 16, wherein receiving the information associated with the MUSIM gap comprises receiving, from the application component of the UE via in-band signaling, an indication of a start of the MUSIM gap and an indication of an end of the MUSIM gap.

Aspect 18: The method of any of Aspects 16-17, wherein receiving the information associated with the MUSIM gap comprises receiving, from the application component of the UE via in-band signaling, an indication of an availability of a radio link for communications that include the MUSIM gap.

Aspect 19: The method of any of Aspects 16-18, wherein receiving the information associated with the MUSIM gap comprises receiving, from the application component of the UE via in-band signaling, an indication of a start of the MUSIM gap and an indication of a duration of the MUSIM gap.

Aspect 20: The method of any of Aspects 16-19, wherein receiving the information associated with the MUSIM gap comprises receiving, from the application component of the UE via in-band signaling, an indication that one or more downlink frames are to collide with the MUSIM gap.

Aspect 21: The method of Aspect 20, wherein the indication that the one or more downlink frames are to collide with the MUSIM gap includes at least one of a frame identifier of a first downlink frame of the one or more downlink frames and a quantity of frames included in the one or more downlink frames.

Aspect 22: The method of any of Aspects 16-21, further comprising applying a downlink service flow that is based at least in part on the information associated with the MUSIM gap.

Aspect 23: The method of Aspect 22, wherein applying the downlink service flow comprises performing at least one of a frame blanking during the MUSIM gap, an intra-coded frame insertion after the MUSIM gap, a predicted frame insertion after the MUSIM gap, or a gradual decoding refresh operation.

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.

Aspect 25: An apparatus for wireless communication at a device, the apparatus comprising one or more memories and one or more processors coupled to the one or more memories, the one or more processors configured to cause the device to perform the method of one or more of Aspects 1-23.

Aspect 26: An apparatus for wireless communication, the apparatus comprising at least one means for performing the method of one or more of Aspects 1-23.

Aspect 27: A non-transitory computer-readable medium storing code for wireless communication, the code comprising instructions executable by one or more processors to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

Aspect 29: A device for wireless communication, the device comprising a processing system that includes one or more processors and one or more memories coupled with the one or more processors, the processing system configured to cause the device to perform the method of one or more of Aspects 1-23.

Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein May be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
signal, by a modem of the UE to an application component of the UE via a cross-layer application programming interface (API), an indication of a start of a multiple user subscriber identity module (MUSIM) gap and an indication of an end of the MUSIM gap; and
transmit, by the application component of the UE to an edge device via in-band signaling, information associated with the MUSIM gap.

2. The apparatus of claim 1, wherein the one or more processors, to cause the application component of the UE to transmit the information associated with the MUSIM gap, are configured to cause the application component of the UE to transmit, to the edge device via in-band signaling, the indication of the start of the MUSIM gap and the indication of the end of the MUSIM gap.

3. The apparatus of claim 1, wherein the one or more processors, to cause the application component of the UE to transmit the information associated with the MUSIM gap, are configured to cause the application component of the UE to transmit, to the edge device via in-band signaling, an indication of an availability of a radio link for communications that include the MUSIM gap.

4. The apparatus of claim 1, wherein the indication of the end of the MUSIM gap is an indication of a duration of the MUSIM gap.

5. The apparatus of claim 1, wherein the one or more processors are further configured to cause the application component of the UE to transmit, to the modem of the UE, an indication of a minimum duration of the MUSIM gap, wherein the indication of the start of the MUSIM gap and the indication of the end of the MUSIM gap are based at least in part on the indication of the minimum duration of the MUSIM gap.

6. The apparatus of claim 1, wherein the one or more processors are further configured to cause the application component of the UE to signal, to the modem of the UE, an indication of a minimum distance between the MUSIM gap and a subsequent MUSIM gap.

7. The apparatus of claim 6, wherein the minimum distance between the MUSIM gap and the subsequent MUSIM gap is a minimum distance between an end of the MUSIM gap and a start of the subsequent MUSIM gap.

8. The apparatus of claim 6, wherein the one or more processors are further configured to cause the modem of the UE to process the MUSIM gap and the subsequent MUSIM gap as a single MUSIM gap based at least in part on a distance between the MUSIM gap and the subsequent MUSIM gap being less than the minimum distance.

9. The apparatus of claim 8, wherein a duration of the single MUSIM gap is equal to a sum of a duration of the MUSIM gap, a duration of the subsequent MUSIM gap, and a duration between the MUSIM gap and the subsequent MUSIM gap.

10. The apparatus of claim 1, wherein the one or more processors, to cause the application component of the UE to transmit the information associated with the MUSIM gap, are configured to cause the application component of the UE to transmit, to the edge device via in-band signaling, an indication that one or more downlink frames are to collide with the MUSIM gap.

11. The apparatus of claim 10, wherein the indication that the one or more downlink frames are to collide with the MUSIM gap includes at least one of a frame identifier of a first downlink frame of the one or more downlink frames and a quantity of frames included in the one or more downlink frames.

12. The apparatus of claim 10, wherein the one or more processors are further configured to cause the application component of the UE to identify the one or more downlink frames based at least in part on an arrival pattern of one or more other downlink frames received by the UE prior to the one or more downlink frames.

13. The apparatus of claim 1, wherein the one or more processors are further configured to cause the application component of the UE to apply an uplink service flow that is based at least in part on the information associated with the MUSIM gap.

14. The apparatus of claim 13, wherein the one or more processors, to cause the application component of the UE to apply the uplink service flow, are configured to cause the application component of the UE to perform at least one of a frame blanking during the MUSIM gap, an intra-coded frame insertion after the MUSIM gap, a predicted frame insertion after the MUSIM gap, or a gradual decoding refresh operation.

15. The apparatus of claim 1, wherein the UE is an extended reality device that includes the modem and the application component.

16. An apparatus for wireless communication at an edge device, comprising:
one or more memories; and
one or more processors, coupled to the one or more memories, configured to cause the edge device to:
receive, from an application component of a user equipment (UE) via in-band signaling, information associated with a multiple user subscriber identity module (MUSIM) gap; and
transmit, to the UE, one or more frames based at least in part on the information associated with the MUSIM gap.

17. The apparatus of claim 16, wherein the one or more processors, to cause the edge device to receive the information associated with the MUSIM gap, are configured to cause the edge device to receive, from the application component of the UE via in-band signaling, an indication of a start of the MUSIM gap and an indication of an end of the MUSIM gap.

18. The apparatus of claim 16, wherein the one or more processors, to cause the edge device to receive the information associated with the MUSIM gap, are configured to cause the edge device to receive, from the application component of the UE via in-band signaling, an indication of an availability of a radio link for communications that include the MUSIM gap.

19. The apparatus of claim 16, wherein the one or more processors, to cause the edge device to receive the information associated with the MUSIM gap, are configured to cause the edge device to receive, from the application component of the UE via in-band signaling, an indication of a start of the MUSIM gap and an indication of a duration of the MUSIM gap.

20. The apparatus of claim 16, wherein the one or more processors, to cause the edge device to receive the information associated with the MUSIM gap, are configured to cause the edge device to receive, from the application component of the UE via in-band signaling, an indication that one or more downlink frames are to collide with the MUSIM gap.

21. The apparatus of claim 20, wherein the indication that the one or more downlink frames are to collide with the MUSIM gap includes at least one of a frame identifier of a first downlink frame of the one or more downlink frames and a quantity of frames included in the one or more downlink frames.

22. The apparatus of claim 16, wherein the one or more processors are further configured to cause the edge device to apply a downlink service flow that is based at least in part on the information associated with the MUSIM gap.

23. The apparatus of claim 22, wherein the one or more processors, to cause the edge device to apply the downlink service flow, are configured to cause the edge device to perform at least one of a frame blanking during the MUSIM gap, an intra-coded frame insertion after the MUSIM gap, a predicted frame insertion after the MUSIM gap, or a gradual decoding refresh operation.

24. A method of wireless communication performed by a user equipment (UE), comprising:
signaling, by a modem of the UE to an application component of the UE via a cross-layer application programming interface (API), an indication of a start of a multiple user subscriber identity module (MUSIM) gap and an indication of an end of the MUSIM gap; and
transmitting, by the application component of the UE to an edge device via in-band signaling, information associated with the MUSIM gap.

25. The method of claim 24, wherein transmitting the information associated with the MUSIM gap comprises transmitting, by the application component of the UE to the edge device via in-band signaling, the indication of the start of the MUSIM gap and the indication of the end of the MUSIM gap.

26. The method of claim 24, further comprising signaling, by the application component of the UE to the modem of the UE, an indication of a minimum duration of the MUSIM gap, wherein the indication of the start of the MUSIM gap and the indication of the end of the MUSIM gap are based at least in part on the indication of the minimum duration of the MUSIM gap.

27. The method of claim 24, further comprising signaling, by the application component of the UE to the modem of the UE, an indication of a minimum distance between the MUSIM gap and a subsequent MUSIM gap.

28. A method of wireless communication performed by an edge device, comprising:
receiving, from an application component of a user equipment (UE) via in-band signaling, information associated with a multiple user subscriber identity module (MUSIM) gap; and
transmitting, to the UE, one or more frames based at least in part on the information associated with the MUSIM gap.

29. The method of claim 28, wherein receiving the information associated with the MUSIM gap comprises receiving, from the application component of the UE via in-band signaling, an indication of a start of the MUSIM gap and an indication of an end of the MUSIM gap.

30. The method of claim 28, wherein receiving the information associated with the MUSIM gap comprises receiving, from the application component of the UE via in-band signaling, an indication of an availability of a radio link for communications that include the MUSIM gap.
